(19) United States
(12) Patent Application Publication
(10) Pub. No.: US 2006/0218646 A1
(43) Pub. Date: Sep. 28, 2006

(54) Method and system for managing digital rights

(76) Inventor: Wilhelmus Franciscus Johannes Fontijn, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/552,763

(22) PCT Filed: Apr. 14, 2004
(86) PCT No.: PCT/IB04/50429

§ 371 Date: Oct. 12, 2005

(30) Foreign Application Priority Data
Apr. 17, 2003 (EP) 03101065.5

(51) Int. Cl. H04L 9/32

(52) U.S. Cl. 726/27

(57) ABSTRACT

In the method of the invention, a request for a digital right to an encrypted content item is transmitted to a server (61). The request contains a circuit identifier identifying an integrated circuit and a content identifier identifying the encrypted content. Subsequently, an encrypted digital right, being encrypted by using a public key associated 5 with the integrated circuit, is received from the server (61). Furthermore, the integrated circuit is instructed to decrypt the encrypted digital right by using a private key associated with the integrated circuit and to store the digital right in the integrated circuit. The private key is being stored in the integrated circuit. The system of the invention contains a client (63) performing the method and a server (61) as referred to in the method. The electronic device 10 performs the method of the invention.

The invention relates to a method of managing digital rights, and in particular to a method comprising the steps of transmitting a request for a digital right to a server and receiving a digital right from the server.

The invention further relates to a computer program enabling a programmable device to carry out a method of managing digital rights.

The invention further relates to a system for managing digital rights, comprising a client which is able to carry out a method of managing digital rights, and a server.

The invention further relates to an electronic device which is able to carry out a method of managing digital rights.

An example of such a method is known from U.S. Pat. No. 6,330,670. The known method comprises transmitting, to a server, a request for a content item and for a digital right to the content item, e.g. a license and/or a content decryption key. The known method is executed by a digital rights management operating system (DRMOS). In one embodiment of the known method, it comprises receiving an encrypted content item, using secure socket layer services and receiving a license placing restrictions on the use of the content item. In this embodiment, the DRMOS writes the encrypted content item to permanent storage and securely stores the session key for later use. The known method provides a certain level of security by including appropriate certificates/identities for a CPU, a DRMOS, and an application in the request. The server will only transmit the content item and the license if it trusts the CPU, the DRMOS, and the application.

Although the DRMOS does protect digital rights from being copied by unauthorized operating system components and unauthorized applications, it does not protect digital rights from being copied by unauthorized hardware components, e.g. snooping devices monitoring communication between a CPU and a memory of an electronic device. Unauthorized copying of a digital right is especially problematic when the digital right provides access to multiple instances of a content item, e.g. as a result of broadcasting the content item.

It is a first object of the invention to provide a method of the type described in the opening paragraph, by which protection against unauthorized hardware components is enhanced.

It is a second object of the invention to provide a system of the type described in the opening paragraph, which is protected better against unauthorized hardware components.

It is a third object of the invention to provide an electronic device of the type described in the opening paragraph, which is protected better against unauthorized hardware components.

According to the invention, the first object is realized in that the method comprises the steps of: transmitting, to a server, a request for a digital right to an encrypted content item, the request comprising a circuit identifier identifying an integrated circuit and a content identifier identifying the encrypted content item; receiving an encrypted digital right from the server, the encrypted digital right being encrypted by using a public key associated with the integrated circuit; and instructing the integrated circuit to decrypt the encrypted digital right by using a private key associated with the integrated circuit, the private key being stored in the integrated circuit, and to store the digital right in the integrated circuit.

To ensure protection against unauthorized hardware components, it is important to use tamperproof hardware components in vulnerable devices and a suitable encryption mechanism between tamperproof hardware components or between a tamperproof hardware component and a trusted device. An integrated circuit may be considered tamperproof. It is extremely difficult to monitor communication between a processor and a memory located in a single integrated circuit, and it is also extremely difficult to continue using an integrated circuit if one were to succeed in reading the memory of the integrated circuit. A suitable encryption mechanism is required for communication between an integrated circuit and other components or devices. By encrypting a digital right with a public key associated with an integrated circuit and storing the matching private key associated with the integrated circuit only in the integrated circuit itself, it can be ensured that only the integrated circuit is able to decrypt the digital right.

A digital right may comprise a license and/or a content decryption key. For example, a license may specify how many times a content item may be reproduced or copied and/or during which period a content item may be reproduced. A content decryption key may be used to decrypt the content item or a part of the content item. A digital right may comprise a plurality of content decryption keys. Alternatively, a digital right may comprise a small software application which is able to generate content decryption keys. Advantageously, the circuit identifier may be hidden in the digital right, thereby creating multiple digital rights to the same content item. In the unlikely case that a digital right or a private key is extracted from an integrated circuit, the server may be able to refuse transmitting another digital right if the request contains the circuit identifier hidden in the compromised digital right.

An embodiment of the method according to the invention further comprises the step of receiving the content identifier identifying the encrypted content item, using a receiver. For example, a content distributor may broadcast the content identifier together with the encrypted content item identified by the content identifier. Alternatively, a mobile phone may receive, for example, a content identifier from a decoder in a set-top box, DVD player, or television. Broadcasting an encrypted content item will generally result in a distribution of multiple instances of the content item, wherein a digital right to the content item provides access to all the multiple instances of the content item. It is then especially important to prevent illegal distribution of the digital right.

The method may further comprise the step of retrieving the content identifier identifying the encrypted content item from a storage means storing the encrypted content item. The content identifier may be stored, for example, on an optical medium, a magnetic medium, or a solid-state memory. The content identifier may be stored with the content item. This embodiment may be performed, for example, by a mobile phone containing a small form factor optical disc reader such as a Portable Blue reader. If content is distributed to multiple users on multiple optical discs, the encryption of each optical disc may either be identical or different. If the encryption of each disc is identical, preventing distribution of a digital right to a content item on the discs is especially important. Encrypting each disc differently in effect creates multiple encrypted content items.

The method may further comprise the step of re-encrypting the digital right and copying the re-encrypted digital right to a storage means. Copying a digital right to a content item from a device performing the method to an external storage means or to an internal storage means containing a removable medium allows reproduction of the content item on another device. To ensure protection against unauthorized software or hardware components, re-encrypting the digital right and copying the re-encrypted digital right to a storage means is advisable. If the license does not allow more than one copy per license, the digital right has to be removed from the device performing the method after copying. An integrated circuit in an optical disc writer may also be used as the integrated circuit of the method. The integrated circuit in the optical disc writer, e.g. a Portable Blue writer, may then be used as the integrated circuit of the method as well as re-encrypt the digital right using a secret key that is only known to authorized integrated circuits. This provides a high level of security.

The method may further comprise the step of obtaining a content decryption key for decrypting at least part of the encrypted content item from the integrated circuit, the content decryption key being computed by the integrated circuit, using the digital right stored in the integrated circuit. This embodiment may be sufficiently secure if the content item is broadcast and relatively quickly loses value, e.g. a sports broadcast. By using different content decryption keys for different parts of a content item or for different content items, parts or content items that have not yet been broadcast cannot be accessed by using a comprised content decryption key.

The method may further comprise the step of transmitting the content decryption key to a content decrypting means. For example, this embodiment may enable a user of a mobile phone to have a set-top box comprising the content decryption means reproduce a content item without the need for the user to insert a smart card into the set-top box.

The method may further comprise the step of obtaining at least a part of the encrypted content item in a decrypted form from the integrated circuit, decryption of the encrypted content item being performed by the integrated circuit, using the digital right stored in the integrated circuit. This embodiment protects a content decryption key from being compromised. The decrypted content item may still be recorded without permission by using unauthorized hardware components, but the decrypted content item is generally much larger than the content decryption key and therefore more difficult to distribute. The integrated circuit may also add a watermark that includes the circuit identifier to the decrypted content item so as to be able to detect whether and where the content item was illegally recorded.

According to the invention, the second object is realized in that the system comprises: a server which is able to receive, from a client, a request for a digital right to an encrypted content item, the request comprising a circuit identifier identifying an integrated circuit and a content identifier identifying the encrypted content item, to perform one of creating and retrieving the digital right; to retrieve a public key associated with the integrated circuit from a server storage means, to encrypt the digital right by using the public key, and to transmit the digital right in an encrypted form to the client; and a client which is able to transmit to the server, the request for the digital right, to receive an encrypted digital right from the server, and to instruct the integrated circuit to decrypt the digital right by using a private key associated with the integrated circuit, the private key being stored in the integrated circuit, and to store the digital right in the integrated circuit.

The server may retrieve, for example, the digital right to the content item if the digital right is identical for all users. The digital right may be retrieved, for example, from an internal storage means or from a further server. The further server may be owned by a trusted third party. The server may alternatively create the digital right to the content item if the digital right should be different for different integrated circuits. The server may be able to store the public key associated with the integrated circuit itself or it may be able to retrieve the public key from another trusted system. For optimal protection, the public key may be retrieved directly from a server owned by a party which is able to verify that the public key is associated with the private key, for example, a party responsible for generating both the private key and the public key. Enabling the server to retrieve the public key, e.g. from a certification authority such as Verisign, instead of allowing the integrated circuit to provide a public key certified by a certification authority is advantageous, because it avoids the problems that may occur when a certificate is compromised, e.g. stolen. An unauthorized party might use the compromised certificate to certify its own public key.

According to the invention, the third object is realized in that the electronic device comprises: a transmitter which is able to transmit a first signal; a receiver which is able to receive a second signal; an integrated circuit which is able to store a private key associated with the integrated circuit, to decrypt an encrypted digital right using the private key, and to store a digital right; and a control unit which is able to instruct the transmitter to transmit, in a first signal, a request for a digital right to an encrypted content item, the request comprising a circuit identifier identifying the integrated circuit and a content identifier identifying the encrypted content item, to use the receiver to receive, in a second signal, an encrypted digital right, the encrypted digital right being encrypted by using a public key associated with the integrated circuit, and to instruct the integrated circuit to decrypt the encrypted digital right and store the digital right.

In an embodiment, the electronic device comprises a mobile phone. Modern mobile phones can increasingly better reproduce content, e.g. MP3 music and MPEG-4 video. With the prospect of distributing small form factor optical discs like Portable Blue discs, whose digital rights may be bought on-line, the need for management of digital rights on a mobile phone has increased.

The electronic device may further comprise a non-volatile memory for storing the digital right in an encrypted form. If it is not possible or not advantageous to store the digital right directly on a permanent storage means, e.g. an optical disc writer containing a writable optical disc, it may be advantageous to store the digital right in a non-volatile memory of the electronic device. For reasons of security, the digital right should be stored in an encrypted form. It may not be advantageous to store the digital right directly on a permanent storage means, when this consumes relatively much power, when the storage means does not contain a standardized key-locker, or when the key-locker cannot be written to. The integrated circuit may also comprise a non-volatile memory, but this may not be large enough to store enough digital rights.

These and other aspects of the method, system, and electronic device of the invention will be further elucidated and described with reference to the drawings, in which:

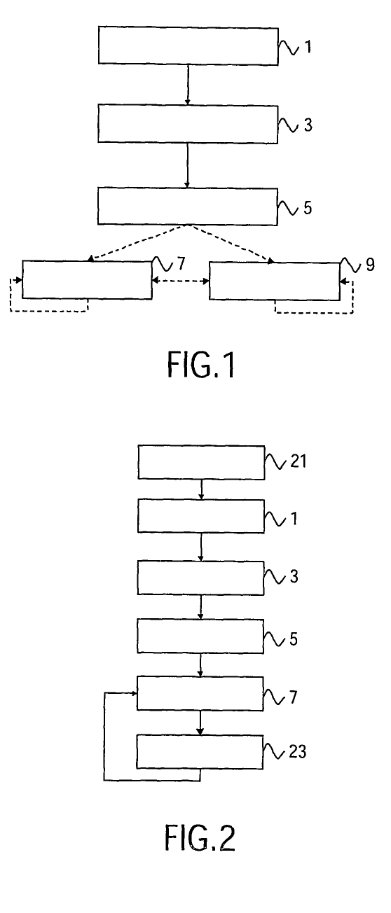

FIG. 1 is a flow chart of the method;

FIG. 2 is a flow chart of a first embodiment of the method;

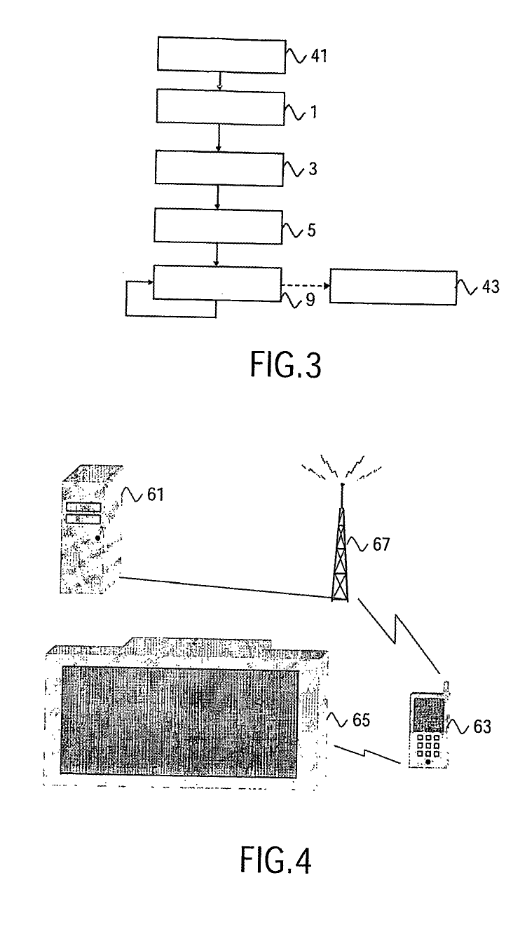

FIG. 3 is a flow chart of a second embodiment of the method;

FIG. 4 is a diagram of an embodiment of the system;

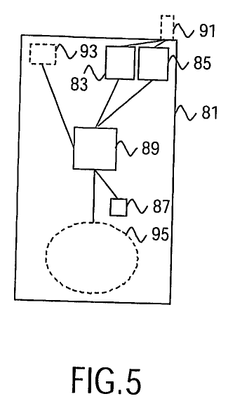

FIG. 5 is a block diagram of the electronic device;

Corresponding elements within the drawings are identified by the same reference numerals.

The method of the invention, see FIG. 1, comprises three steps. Step 1 comprises transmitting, to a server, a request for a digital right to an encrypted content item, the request comprising a circuit identifier identifying an integrated circuit and a content identifier identifying the encrypted content item. Step 3 comprises receiving an encrypted digital right from the server, the encrypted digital right being encrypted by using a public key associated with the integrated circuit. Step 5 comprises instructing the integrated circuit to decrypt the encrypted digital right by using a private key associated with the integrated circuit, the private key being stored in the integrated circuit, and to store the digital right in the integrated circuit. The integrated circuit may be a relatively simple microchip, as present on most smart cards, or a powerful microprocessor. Step 5 may be performed, for example, directly after step 3 or just before a subsequent step. In the latter case, the encrypted digital right is temporarily stored elsewhere, e.g. in a non-volatile memory.

The method may further comprise step 7 and/or step 9. Step 7 comprises obtaining a content decryption key for decrypting at least part of the encrypted content item from the integrated circuit, the content decryption key being computed by the integrated circuit, using the digital right stored in the integrated circuit. A content decryption key may enable decryption of a part of the content item or of the entire content item. Step 9 comprises obtaining at least a part of the encrypted content item in a decrypted form from the integrated circuit, decryption of the encrypted content item being performed by the integrated circuit using the digital right stored in the integrated circuit.

The first embodiment of the method, see FIG. 2, comprises step 21 of receiving the content identifier identifying the encrypted content item, using a receiver. In this embodiment, the content identifier is received from a content decrypting means, for example, a decoder embedded in a set-top box or DVD player. The receiver may be, for example, a radio frequency receiver. The first embodiment further comprises step 1 transmitting, to a server, a request for a digital right to an encrypted content item, step 3 receiving an encrypted digital right from the server, and step 5 instructing the integrated circuit to decrypt the encrypted digital right by using a private key associated with the integrated circuit. The first embodiment also comprises step 7 obtaining a content decryption key for decrypting at least part of the encrypted content item from the integrated circuit, the content decryption key being computed by the integrated circuit, using the digital right stored in the integrated circuit. Additionally, the first embodiment of the method comprises step 23 transmitting the content decryption key to the content decrypting means.

The second embodiment of the method, see FIG. 3, comprises step 41 retrieving the content identifier identifying the encrypted content item from a storage means storing the encrypted content item. The storage means may be, for example, an optical disc reader containing an optical disc, a magnetic storage means, e.g. a hard disk, or a solid-state memory, e.g. MRAM. The second embodiment further comprises step 1 transmitting, to a server, a request for a digital right to an encrypted content item, step 3 receiving an encrypted digital right from the server, and step 5 instructing the integrated circuit to decrypt the encrypted digital right by using a private key associated with the integrated circuit.

The second embodiment of the method also comprises step 9 obtaining at least a part of the encrypted content item in a decrypted form from the integrated circuit, decryption of the encrypted content item being performed by the integrated circuit, using the digital right stored in the integrated circuit. The integrated circuit may comprise, for example, a digital signal processor optimized for MPEG-2 or MPEG-4 decoding. The at least part of the content may be obtained, for example, with a request comprising the content identifier. Alternatively, the content identifier may be communicated to the integrated circuit before any part of the content item is obtained. Additionally, the second embodiment comprises step 43 re-encrypting the digital right and copying the re-encrypted digital right to a storage means. This is possible if the storage means is writable, for example, if it comprises an optical disc writer containing a writable optical disc. The optical disc may contain a standardized key-locker in which the digital right may be securely stored.

The embodiment of the system of the invention, see FIG. 4, comprises a server 61 and a client 63. The server 61 is able to receive, from a client 63, a request for a digital right to an encrypted content item, the request comprising a circuit identifier identifying an integrated circuit embedded in the client 63 and a content identifier identifying the encrypted content item. The server 61 is further able to perform one of creating and retrieving the digital right and to retrieve a public key associated with the integrated circuit from a server storage means. The server 61 is also able to encrypt the digital right by using the public key and to transmit the digital right in an encrypted form to the client 63. In FIG. 4, the server 61 is a computer connected to the Internet. The client 63 is able to transmit, to the server 61, the request for the digital right. The client 63 is further able to receive an encrypted digital right from the server 61. The client 63 is also able to instruct the integrated circuit to decrypt the digital right by using a private key associated with the integrated circuit, the private key being stored in the integrated circuit, and to store the digital right in the integrated circuit.

In FIG. 4, the client 63 is a mobile phone which is able to communicate with a content decrypting means embedded in another device 65, e.g. in a TV. In this embodiment, the client 63 transmits to and receives from a base station 67 of a wireless network, e.g. a UMTS network or a wireless LAN. The server 61 transmits and receives through a wired network. Alternatively, the client 63 may be, for example, a set-top box, a DVD player, a TV, or an external decoder and the client 63 and/or the server 61 may communicate by using any other network technology. The client 63 and the server 61 may communicate via a bridge device. The client 63, e.g. a set-top box, may communicate, for example, with the server 61 via a mobile telephone. The client 63 and the mobile telephone may communicate, for example, by using Bluetooth while the mobile telephone and the server 61 may communicate by using UMTS.

The electronic device 81 of the invention, see FIG. 5, comprises a transmitter 83, a receiver 85, an integrated circuit 87, and a control unit 89. The transmitter 83 is able to transmit a first signal. The receiver 85 is able to receive a second signal. The signal may be, for example, a radio signal, an optical signal, or an electric signal. The transmitter 83 and the receiver 85 may be the same physical component, e.g, a Radio Frequency transceiver. The transmitter 83 and the receiver 85 may be able to communicate with a base station of a wireless network, using an antenna 91. The antenna 91 may be internal or external. The integrated circuit 87 is able to store a private key associated with the integrated circuit 87, to decrypt an encrypted digital right by using the private key; and to store a digital right. The integrated circuit 87 may be, for example, a powerful microprocessor or a relatively simple microchip as found on smart cards. The control unit 89 is able to instruct the transmitter 83 to transmit, in a first signal, a request for a digital right to an encrypted content item, the request comprising a circuit identifier identifying the integrated circuit 87 and a content identifier identifying the encrypted content item. The control unit 89 is further able to use the receiver 85 to receive, in a second signal, an encrypted digital right, the encrypted digital right being encrypted by using a public key associated with the integrated circuit 87. The control unit 89 is also able to instruct the integrated circuit 87 to decrypt the encrypted digital right and store the digital right in the circuit's memory. The control unit 89 may be, for example, a microprocessor. The control unit 89 and the integrated circuit 87 may be the same physical component. The integrated circuit 87 comprises a writable memory for storing the digital right. The writable memory may be volatile, e.g. a RAM or non-volatile, e.g. a MRAM or EEPROM.

The electronic device 81 may comprise a mobile phone. Alternatively, the electronic device 81 may comprise a TV, a set-top box, or a DVD player. The electronic device 81 may further comprise a non-volatile memory 93 for storing the digital right in an encrypted form. The non-volatile memory 93 may be, for example, a MRAM or a Flash memory. The non-volatile memory 93 may be used to store encrypted digital rights for a longer period of time. The integrated circuit 87 may use, for example, a secret password to encrypt the digital rights or it may use its own public key. The electronic device 91 may comprise an optical disc writer 95, e.g. a Portable Blue writer. The optical disc writer 91 may use the integrated circuit 87 for storing the digital rights on an optical disc.

While the invention has been described in connection with preferred embodiments, it will be understood that modifications thereof within the principles outlined above will be evident to those skilled in the art, and thus the invention is not limited to the preferred embodiments but is intended to encompass such modifications. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

As will be apparent to a person skilled in the art, ‘means’ are meant to include any hardware (such as separate circuits or electronic elements) or software (such as programs or parts of programs) which perform in operation or are designed to perform a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Computer program’ is to be understood to mean any software product stored on a computer-readable medium, such as a floppy disk, downloadable via a network, such as the Internet, or marketable in any other manner.

1. A method of managing digital rights, comprising the steps of:
transmitting (1), to a server, a request for a digital right to an encrypted content item, the request comprising a circuit identifier identifying an integrated circuit and a content identifier identifying the encrypted content item;
receiving (3) an encrypted digital right from the server, the encrypted digital right being encrypted by using a public key associated with the integrated circuit; and
instructing (5) the integrated circuit to decrypt the encrypted digital right by using a private key associated with the integrated circuit, the private key being stored in the integrated circuit, and to store the digital right in the integrated circuit.

2. A method as claimed in claim 1, further comprising the step of receiving (21) the content identifier identifying the encrypted content item, using a receiver.

3. A method as claimed in claim 1, further comprising the step of retrieving (41) the content identifier identifying the encrypted content item from a storage means storing the encrypted content item.

4. A method as claimed in claim 1, further comprising the step of re-encrypting (43) the digital right and copying the re-encrypted digital right to a storage means.

5. A method as claimed in claim 1, further comprising the step of obtaining (7) a content decryption key for decrypting at least part of the encrypted content item from the integrated circuit, the content decryption key being computed by the integrated circuit, using the digital right stored in the integrated circuit.

6. A method as claimed in claim 5, further comprising the step of transmitting (23) the content decryption key to a content decrypting means.

7. A method as claimed in claim 1, further comprising the step of obtaining (9) at least a part of the encrypted content item in a decrypted form from the integrated circuit, decryption of the encrypted content item being performed by the integrated circuit, using the digital right stored in the integrated circuit.

8. A computer program enabling a programmable device to carry out a method as claimed in claim 1.

9. A system for managing digital rights, comprising:
a server (61) which is able to receive, from a client, a request for a digital right to an encrypted content item, the request comprising a circuit identifier identifying an integrated circuit and a content identifier identifying the encrypted content item; to perform one of creating and retrieving the digital right; to retrieve a public key associated with the integrated circuit from a server storage means; to encrypt the digital right by using the public key; and to transmit the digital right in an encrypted form to the client (63); and
a client (63) which is able to transmit, to the server (61), the request for the digital right; to receive an encrypted digital right from the server (61); and to instruct the integrated circuit to decrypt the digital right by using a private key associated with the integrated circuit, the private key being stored in the integrated circuit, and to store the digital right in the integrated circuit.

10. An electronic device (81), comprising:
a transmitter (83) which is able to transmit a first signal;
a receiver (85) which is able to receive a second signal;
an integrated circuit (87) which is able to store a private key associated with the integrated circuit; to decrypt an encrypted digital right by using the private key; and to store a digital right; and
a control unit (89) which is able to instruct the transmitter to transmit, in a first signal, a request for a digital right to an encrypted content item, the request comprising a circuit identifier identifying the integrated circuit and a content identifier identifying the encrypted content item; to use the receiver to receive, in a second signal, an encrypted digital right, the encrypted digital right being encrypted by using a public key associated with the integrated circuit; and to instruct the integrated circuit to decrypt the encrypted digital right and to store the digital right.

11. An electronic device (81) as claimed in claim 10, comprising a mobile phone.

12. An electronic device (81) as claimed in claim 10, further comprising a non-volatile memory (93) for storing the digital right in an encrypted form.
